(19) United States
(12) Patent Application Publication
(10) Pub. No.: US 2017/0328550 A1
(43) Pub. Date: Nov. 16, 2017

(54) HEAT DISSIPATION STRUCTURE AND ILLUMINATION DEVICE

(71) Applicants: Takenobu HONGO, Fukushima (JP); Katsuro TSUKAMOTO, Sennan-shi, Osaka (JP)

(72) Inventor: Takenobu HONGO, Fukushima (JP)

(21) Appl. No.: 15/525,862

(22) PCT Filed: Nov. 10, 2015
(86) PCT No.: PCT/JP2015/081652

§ 371 Date: May 10, 2017

(30) Foreign Application Priority Data
Nov. 12, 2014 (JP) 2014-229848

(51) Int. Cl. F21V 29/507; F21K 9/233; H05B 33/08; B32B 27/08; C01B 32/20; F21Y 2115/10

(52) U.S. Cl. CPC F21V 29/507; F21K 9/233; H05B 33/0848; C01B 32/20; F21Y 2115/10; B32B 2307/202; B32B 2307/302; B32B 27/08

(57) ABSTRACT

Provided is a heat dissipation structure and an illumination device which are capable of dissipating heat readily and efficiently. A heat dissipation structure 1 configured to release heat from a heat source 100 is provided with a plurality of heat reception/dissipation members 10 which have expanded graphite layers containing expanded graphite and which are spaced apart from each other; and a connection member 20 configured to connect the heat reception/dissipation members 10 together. The heat reception/dissipation members 10 each have the expanded graphite layer as the outermost layer and are disposed such that the expanded graphite layers face each other.

### CROSS-REFERENCE TO RELATED APPLICATIONS

This application is a national phase filing under 35 USC §371 of International Application No. PCT/JP2015/081652, filed Nov. 10, 2015, and which claims priority to Japanese Patent Application No. 2014-229848, filed on Nov. 12, 2014, the contents of which are incorporated herein by reference.

### STATEMENT REGARDING PRIOR DISCLOSURE BY THE INVENTOR OR A JOINT INVENTOR UNDER 37 CFR 1.77(B) (6)

A device corresponding to the invention claimed in this application and made by Takenobu Hongo was sold or offered for sale by Applicant on the following dates: Aug. 8, 2014; Aug. 20, 2014; Aug. 25, 2014; Sep. 2, 2014; Sep. 12, 2014; Sep. 17, 2014; Sep. 22, 2014; Oct. 20, 2014; and Oct. 24, 2014. The device was also exhibited to the public by Applicant on the following dates: Sep. 15, 2014; and Sep. 30, 2014. The effective filing date of this application is Nov. 12, 2014. The details of the sales and exhibitions were described in a document filed at the Japan Patent Office to establish the exception to the loss of novelty. The document as well as its translation will be submitted with an Information Disclosure Statement.

### FIELD OF THE INVENTION

The present invention relates to a heat dissipation structure that receives and then releases heat emitted from a heat source, and an illumination device provided with this heat dissipation structure.

### BACKGROUND OF THE INVENTION

Conventionally, for example, electronic components, such as LEDs or CPUs, which generate a large amount of heat are required to be provided with an appropriate heat dissipation structure in order to prevent deterioration or malfunction due to heat. In general, such a heat dissipation structure is provided with a number of heat dissipating fins made of a metal having a high thermal conductivity, such as aluminum and copper, and is configured to dissipate heat by transferring heat to the air in contact with the heat dissipating fins (for example, see Patent Literature 1). Furthermore, in order to efficiently diffuse heat in such a heat dissipation structure, a technique for utilizing a graphite sheet having an anisotropic thermal conductivity is suggested (for example, see Patent Literature 2).

### PATENT LITERATURE

Patent Literature 1: Japanese Patent Application Laid-Open No. 2014-170673
Patent Literature 2: Japanese Patent Application Laid-Open No. 2008-28352

### SUMMARY OF THE INVENTION

However, since the conventional heat dissipation structure illustrated in Patent Literature 1 above is provided with a number of heat dissipating fins made of a metal so as to be in contact with air, the heat dissipation structure disadvantageously occupied too much space. Furthermore, for example, an additional blower fan had to be provided, depending on service conditions or environments, to positively bring air into contact with the heat dissipating fins. In some cases, this prevented the device to be provided with the heat dissipation structure from being made compact.

In particular, an illumination device disposed at a high position such as the ceiling has been strongly required to be not only made compact but also reduced in weight from the viewpoint of safety. In such an illumination device, it was difficult for the conventional heat dissipation structure to be provided with sufficient heat dissipating property and reduced in weight at the same time. Furthermore, a housing or the like also used as the heat dissipation structure in order to implement compactness caused the structure to become complicated in conjunction with degradation in heat dissipation efficiency and an increase in manufacturing costs.

Furthermore, the technique illustrated in Patent Literature 2 above allowed heat from the LED chips to be efficiently diffused through the graphite layers. However, since the heat was finally released, for example, through the metal layers or the heat dissipating fins, the heat dissipation efficiency was not so high. With the heat dissipating fins or the like provided, the space occupied by the heat dissipation structure remained not reduced.

The present invention has been developed in view of the aforementioned problems, and intended to provide a heat dissipation structure and an illumination device which are capable of dissipating heat in a simplified and efficient manner.

The present invention is a heat dissipation structure configured to release heat from a heat source. The heat dissipation structure is characterized by including: a plurality of heat reception/dissipation members having an expanded graphite layer containing expanded graphite, the heat reception/dissipation members being spaced apart from each other; and a connection member configured to connect together the heat reception/dissipation members, and in that the heat reception/dissipation members each have the expanded graphite layer as an outermost layer and are disposed such that the expanded graphite layers face each other.

The present invention is also characterized in that in the heat dissipation structure of the aforementioned means, the heat reception/dissipation members are arranged in a direction in which a distance from the heat source increases.

The present invention is also characterized in that in the heat dissipation structure of the aforementioned means, the heat reception/dissipation members are disposed so that the expanded graphite layers intersect a direction in which the heat reception/dissipation members are arranged.

The present invention is also characterized in that in the heat dissipation structure of the aforementioned means, the heat reception/dissipation member has a metal layer made of a metal, and the expanded graphite layer is provided on both sides of the metal layer.

The present invention is also characterized in that in the heat dissipation structure of the aforementioned means, the connection member has a connection expanded graphite layer containing expanded graphite, and the connection expanded graphite layer is provided so as to intersect the expanded graphite layers.

The present invention is also characterized in that in the heat dissipation structure of the aforementioned means, the connection member has the connection expanded graphite layer formed in a spiral shape.

The present invention is also characterized in that in the heat dissipation structure of the aforementioned means, the connection member has a plurality of the connection expanded graphite layers.

The present invention is also characterized in that in the heat dissipation structure of the aforementioned means, the connection member has a connection metal layer made of a metal, and the connection metal layer is provided substantially in parallel to the connection expanded graphite layer.

The present invention is also characterized in that in the heat dissipation structure of the aforementioned means, the connection member is disposed across the plurality of heat reception/dissipation members.

The present invention is also characterized in that in the heat dissipation structure of the aforementioned means, the connection member is inserted into a through hole formed in the heat reception/dissipation members.

The present invention is also characterized in that in the heat dissipation structure of the aforementioned means, the connection member is disposed between the heat source and the heat reception/dissipation member.

Furthermore, the present invention is an illumination device including the heat dissipation structure of the aforementioned means and a light source configured to emit light.

The present invention is also characterized, in the illumination device of the aforementioned means, by including: an illuminance sensor configured to detect ambient brightness, and a control device configured to control turning on and turning off of the light source on the basis of a detection result provided by the illuminance sensor.

The heat dissipation structure and the illumination device according to the present invention can have the excellent effects of being capable of dissipating heat in a simplified and efficient manner.

### BRIEF DESCRIPTION OF THE DRAWINGS

FIG. 1(a) is a schematic plan view illustrating a heat dissipation structure according to an embodiment of the present invention, and FIG. 1(b) is a schematic front view illustrating the heat dissipation structure.

FIG. 2(a) is an enlarged schematic cross-sectional view illustrating part of the heat dissipation structure, and FIG. 2(b) is a schematic perspective view illustrating a connection member.

FIGS. 3(a) to 3(d) are schematic views illustrating a method for manufacturing the connection member.

FIG. 4 is a schematic view illustrating an aspect in which a heat dissipation structure is dissipating heat.

FIGS. 5(a) to 5(d) are schematic views illustrating, as an example, a heat dissipation structure in another form.

FIGS. 6(a) to 6(e) are schematic views illustrating, as an example, a heat dissipation structure in another form.

FIGS. 7(a) and 7(b) are schematic views illustrating, as an example, a heat dissipation structure in another form.

FIG. 8(a) is a schematic front view illustrating an illumination device according to an embodiment of the present invention; FIG. 8(b) is a schematic bottom view illustrating the illumination device; and FIG. 8(c) is a cross-sectional view taken along line B-B in FIG. 8(b).

FIGS. 9(a) and 9(b) are schematic cross-sectional views illustrating, as an example, an illumination device in another form.

FIG. 10 is a schematic cross-sectional view illustrating, as an example, an illumination device when configured as a street light.

### DETAILED DESCRIPTION OF THE INVENTION

Now, with reference to the accompanying drawings, an embodiment of the present invention will be described. Note that for ease of understanding, each of the figures below may include those parts that are not illustrated or are illustrated in a simplified manner, and respective parts are not always drawn to scale.

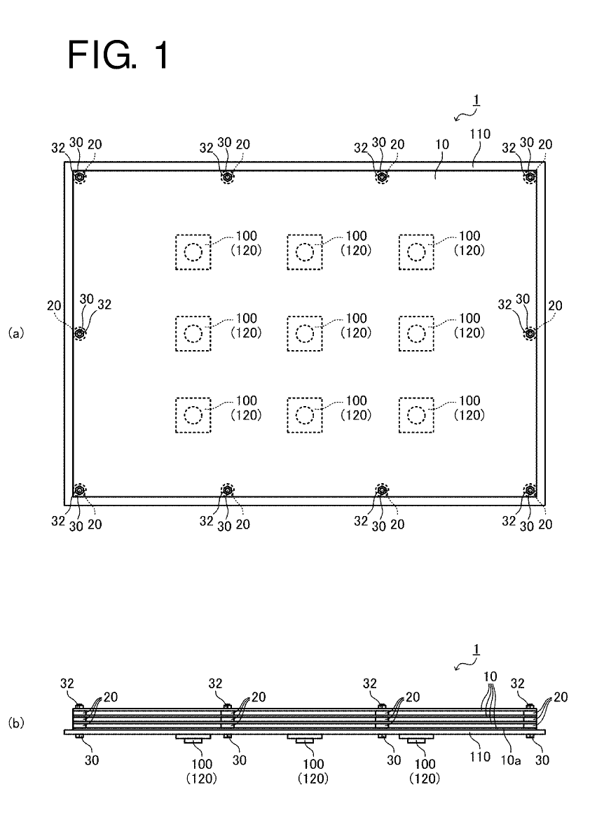

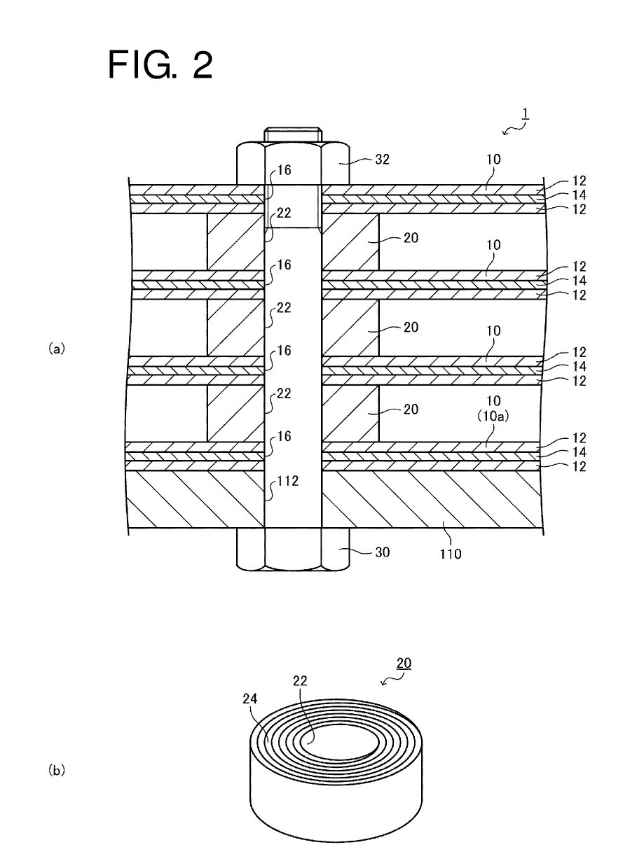

First, a description will be given of a heat dissipation structure 1 according to this embodiment. FIG. 1(a) is a schematic plan view illustrating the heat dissipation structure 1 according to this embodiment, and FIG. 1(b) is a schematic front view illustrating the heat dissipation structure 1. In addition, FIG. 2(a) is an enlarged schematic cross-sectional view illustrating part of the heat dissipation structure 1, and FIG. 2(b) is a schematic perspective view illustrating connection members 20. The heat dissipation structure 1 is to release heat emitted from heat sources 100, and as illustrated in the figures, provided with a plurality of heat reception/dissipation members 10 and the connection members 20. Note that as shown in FIGS. 1(a) and 1(b), this embodiment employs nine LED modules 120 disposed as the heat sources 100 on a substrate 110.

The heat reception/dissipation members 10 are to receive heat emitted from the heat sources 100 (to receive heat) and then release the heat into the air (to dissipate heat). The heat reception/dissipation members 10 are each configured in a substantially rectangular flat shape, and in this embodiment, four heat reception/dissipation members 10 are arranged in a direction in which a distance increases from the heat sources 100 (in the upward direction in FIGS. 1(b) and 2(a)).

As shown in FIG. 2(a), the heat reception/dissipation member 10 is provided with two expanded graphite layers 12 made of expanded graphite, and as well, provided with a metal layer 14 made of a metal between the two expanded graphite layers 12. That is, the heat reception/dissipation member 10 is configured in a three-layer structure that has the expanded graphite layers 12 as the outermost layers. Furthermore, the expanded graphite layers 12 and the metal layer 14 are disposed to intersect (to be substantially orthogonal to) the direction in which a distance increases from the heat sources 100.

In this embodiment, two expanded graphite sheets are stacked on both sides of a metal sheet and then bonded together under pressure, for example, by press so as to form the heat reception/dissipation member 10. The expanded graphite sheet is obtained by quickly heating graphite powder, in which an intercalation compound has been produced by a strong acid, such as sulfuric acid or nitric acid, to expand the graphite powder, and compression molding the obtained expanded graphite powder into a sheet shape.

The expanded graphite sheet has characteristics in which its thermal conductivity in the thickness direction is low, but its thermal conductivity in the planar direction is very high. Furthermore, the graphite contained in the expanded graphite sheet has characteristics in which heat emissivity and absorptivity are high. As will be discussed in detail later, in this embodiment, effective use of such characteristics of the expanded graphite sheet enables efficient dissipation of heat from the heat sources 100. Furthermore, in this embodiment, the heat reception/dissipation member 10 is provided with the metal layer 14 in conjunction with the expanded graphite layers 12. This allows the heat reception/dissipation member 10 to have appropriate strength and rigidity though the expanded graphite sheet of a relatively brittle material is used.

Note that as a matter of course, the expanded graphite layer 12 may also contain, for example, various types of binders other than the expanded graphite, and as well, may also be mixed with, for example, various types of metals for controlling the thermal conductivity in the thickness direction. Furthermore, a metal constituting the metal layer 14 is not limited to a particular type, but may preferably be a metal having a high thermal conductivity, such as aluminum and copper, or an alloy thereof, and from the viewpoint of weight and cost, may preferably be aluminum or an aluminum alloy.

Of the four heat reception/dissipation members 10, the heat reception/dissipation member 10a that is disposed closest to the heat sources 100 is disposed in close contact with the substrate 110. Specifically, in this embodiment, the heat reception/dissipation member 10a and the substrate 110 are stacked one on the other and then bonded together under pressure, for example, by press. Provision of the expanded graphite layers 12 as the outermost layers makes it possible to readily bond the heat reception/dissipation member 10 to another member under pressure. Then, the enhancement of the adhesion property between the substrate 110 and the heat reception/dissipation member 10a by the bonding under pressure enables efficient transfer of heat from the substrate 110, on which the LED modules 120 serving as the heat sources 100 are disposed, to the heat reception/dissipation member 10a.

Note that the shape, the size, and the number of the heat reception/dissipation members 10 are not limited to particular ones, but may be set, as appropriate, depending on the amount of heat generated by and the number of the heat sources 100 and the structure of a device in which the heat dissipation structure 1 is provided. Furthermore, for example, to control air flow, a hole penetrating in the thickness direction may also be provided to the heat reception/dissipation members 10.

Furthermore, the heat reception/dissipation member 10a nearest to the heat sources 100 may also be used as the substrate 110. In this case, for example, the heat reception/dissipation member 10a may also be configured by bonding the expanded graphite sheet under pressure to the surface of the substrate 110 which is made of, for example, an aluminum alloy and opposite to the heat sources 100. On the other hand, the heat reception/dissipation member 10a may also be used as the substrate 110 by adding, for example, a metal or resin reflecting layer for reflecting light or a metal or resin protection layer for protecting the expanded graphite layer 12, to the outermost layer of the heat reception/dissipation member 10a which is located close to the heat sources 100 and which has a three-layer structure of the expanded graphite layer 12-the metal layer 14-the expanded graphite layer 12. That is, the heat reception/dissipation member 10a disposed closest to the heat sources 100 may also have the expanded graphite layer 12 only as one outermost layer.

The connection members 20 are each disposed between the heat reception/dissipation members 10, acting to connect between the plurality of heat reception/dissipation members 10 and functioning as a spacer for allowing the members to be spaced from each other at appropriate intervals. The connection member 20 also functions as a heat transfer member configured to transfer heat from one heat reception/dissipation member 10 to another heat reception/dissipation member 10 by being brought into contact with the two heat reception/dissipation members 10. Note that in this embodiment, as shown in FIGS. 1(a) and 1(b), the connection members 20 are disposed at ten positions in the vicinity of the peripheral edge of the heat reception/dissipation members 10.

As shown in FIG. 2(b), the connection member 20 is configured in a substantially cylindrical shape having a through hole 22 at the center thereof. The through hole 22 allows a fastening bolt 30 to be inserted thereinto. Then, as shown in FIG. 2(a), there are provided through holes 16 and 112, which allow the bolt 30 to be inserted thereinto, at the predetermined positions of the heat reception/dissipation members 10 and the substrate 110. That is, in this embodiment, the connection members 20 are disposed at the positions corresponding to the through holes 16 and 112 of the heat reception/dissipation members 10 and the substrate 110, and then the bolt 30 inserted into each of the through holes 16, 22, and 112, and a nut 32 are tightened. This allows the four heat reception/dissipation members 10 to be spaced from each other at appropriate intervals and the heat dissipation structure 1 to be fixed to the substrate 110.

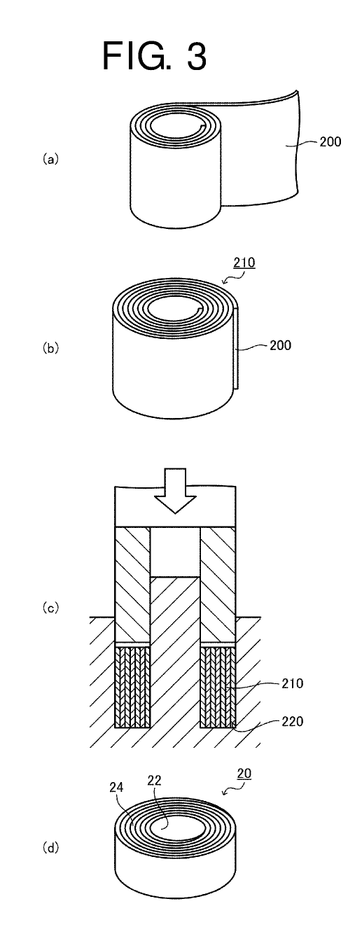

As described above, the connection member 20 functions as a spacer and also as a heat transfer member. Thus, in this embodiment, the heat transfer by the connection member 20 is facilitated by configuring the connection member 20 from an expanded graphite tape which is formed in a strip by the compression molding of expanded graphite and wound substantially in a coil (cylindrical) shape. FIGS. 3(a) to 3(d) are schematic views illustrating a method for manufacturing the connection member 20.

In manufacturing the connection member 20, first, as shown in FIG. 3(a), an expanded graphite tape 200, or an expanded graphite sheet substantially in a strip shape, is wound into a coil shape, and then as shown in FIG. 3(b), formed into a raw member 210. Then, as shown in FIG. 3(c), the raw member 210 is axially pressed while being accommodated in a cylindrical mold 220 to which a predetermined inner diameter and an outer diameter are set. This causes the wound expanded graphite tape 200 to be bonded together under pressure in a spiral shape, and as shown in FIG. 3(d), leads to the connection member 20 formed in a substantially cylindrical shape by compression molding.

The expanded graphite tape 200 (i.e., the expanded graphite sheet) has an excellent thermal conductivity in the planar direction as the characteristics thereof. The connection member 20 is formed from the expanded graphite tape 200 wound in a spiral shape in this manner, and thus, this enables the thermal conductivity of the connection member 20 to be increased in the axial direction (in the vertical direction of FIG. 3(d)) because the expanded graphite tape 200 can be formed in a substantially cylindrical shape by compression molding while the direction in which the expanded graphite tape 200 has an excellent thermal conductivity is being aligned with the axial direction. That is, since the spiral-shaped expanded graphite layers 24 enable quick heat transfer in the axial direction, it is possible to facilitate heat transfer from a heat reception/dissipation member 10 located closer to the heat sources 100 to the adjacent heat reception/dissipation member 10 through the connection member 20.

Furthermore, in this embodiment, as described above, the heat reception/dissipation members 10 and the connection members 20 are tightened by the bolt 30 and the nut 32. Thus, the tightening force of the bolt 30 and the nut 32 causes the expanded graphite layers 12 of the heat reception/dissipation members 10 and the connection members 20 to be appropriately bonded together under pressure. As a result, heat can be efficiently transferred between the heat reception/dissipation members 10 and the connection members 20.

Note that the shape of the connection member 20 is not limited to a substantially cylindrical shape but may also be another shape.

Furthermore, the expanded graphite tape 200 may also contain various types of binders or metals other than the expanded graphite, and may also include a metal layer or a resin layer for reinforcement. Furthermore, the heat reception/dissipation members 10 and the connection members 20 may also be fixed, for example, by bonding or mating other than the technique by tightening the bolt 30 and the nut 32.

Furthermore, the connection member 20 may also be configured from another material, for example, a metal having a high thermal conductivity, such as aluminum and copper, or an alloy thereof. Furthermore, the positions at which the connection members 20 are disposed and the number of the connection members 20 are not limited to particular ones, but may be appropriately set depending on the shape, the size or the like of the heat reception/dissipation members 10.

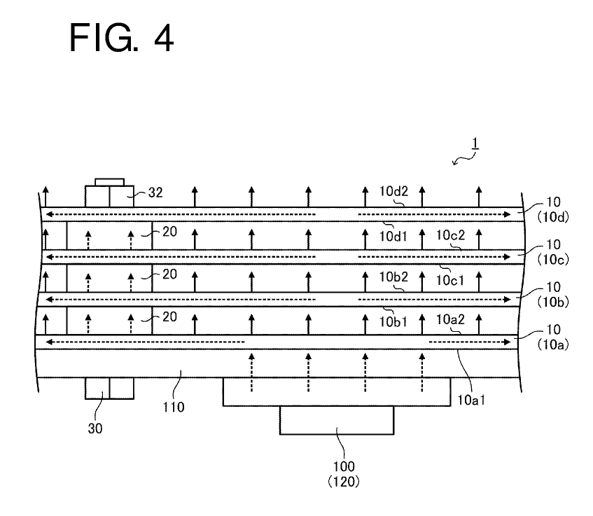

Now, a description will be given of the operation of the heat dissipation structure 1. FIG. 4 is a schematic view illustrating the heat dissipation structure 1 which is dissipating heat.

As shown in FIG. 4, the heat emitted from the heat sources 100 is first transferred through the substrate 110 to a heat reception side surface 10a1 that is the surface of the heat reception/dissipation member 10a located closest to the heat sources 100 and is closer to the heat sources 100. In this embodiment, since the substrate 110 and the heat reception/dissipation member 10a are bonded together under pressure to thereby enhance the adhesion property therebetween, it is thus possible to efficiently transfer heat from the substrate 110 to the heat reception side surface 10a1 of the heat reception/dissipation member 10a.

Note that the material of the substrate 110 is not limited to a particular one. However, it is possible to transfer the heat emitted from the heat sources 100 more efficiently to the heat reception side surface 10a1 by using a material having a high thermal conductivity, such as aluminum and copper. Furthermore, the outermost expanded graphite layer 12 constituting the heat reception side surface 10a1 of the heat reception/dissipation member 10a has an excellent heat emissivity and absorptivity. It is thus possible to transfer sufficient heat to the heat reception/dissipation member 10a even by heat radiation by employing a material that transmits electromagnetic waves, as appropriate, as a material of the substrate 110.

The heat transferred to the heat reception side surface 10a1 of the heat reception/dissipation member 10a is diffused and transferred mainly in the planar direction (the right-and-left direction of FIG. 4) due to the difference in thermal conductivity between the planar direction and the thickness direction of the outermost expanded graphite layers 12. Then, the heat is gradually transferred in the thickness direction while being diffused and transferred in the planar direction and then reaches a heat dissipation side surface 10a2 or the surface of the heat reception/dissipation member 10a opposite to the heat sources 100. Part of the heat that has reached the heat dissipation side surface 10a2 is transferred to the air that is in contact with the heat dissipation side surface 10a2. Furthermore, since the outermost expanded graphite layer 12 constituting the heat dissipation side surface 10a2 of the heat reception/dissipation member 10a has an excellent heat emissivity as described above, part of the heat that has reached the heat dissipation side surface 10a2 is transferred to the nearby air by heat radiation. This allows part of the heat emitted from the heat sources 100 to be released into the air.

Of the heat dissipation side surface 10a2 of the heat reception/dissipation member 10a, heat is transferred to the connection member 20 at the portion in contact with the connection member 20. The heat transferred to the connection member 20 is immediately transferred through the expanded graphite layer 24 in the axial direction (in the vertical direction of FIG. 4) and then transferred to a heat reception side surface 10b1 of a heat reception/dissipation member 10b adjacent to the heat reception/dissipation member 10a. Furthermore, since the expanded graphite layer 12 constituting the heat reception side surface 10b1 of the heat reception/dissipation member 10b has an excellent heat absorptivity as described above, heat is also transferred to the opposed heat reception side surface 10b1 of the heat reception/dissipation member 10b by heat radiation even at the portion that is of the heat dissipation side surface 10a2 of the heat reception/dissipation member 10a not in contact with the connection member 20.

As with the case of the heat reception/dissipation member 10a, the heat transferred to the heat reception side surface 10b1 of the heat reception/dissipation member 10b is immediately diffused in the planar direction and then part thereof is released into the air from the heat dissipation side surface 10b2 and part thereof is transferred to an adjacent heat reception/dissipation members 10c. The same as the heat reception/dissipation member 10b holds true for the heat reception/dissipation member 10c. In a heat reception/dissipation member 10d, since no heat reception/dissipation member 10 is disposed near a heat dissipation side surface 10d2 thereof, most heat is released into the air. Note that as a matter of course, in the heat reception/dissipation members 10b, 10c, and 10d, heat is also dissipated into the air from the heat reception side surfaces 10b1, 10c1, and 10d1.

As described above, in this embodiment, it is possible not only to diffuse heat immediately in the planar direction within one heat reception/dissipation member 10 but also to transfer heat to a plurality of heat reception/dissipation members 10 one after another by transferring heat through the connection member 20 and by transferring heat by heat radiation from the surface of the heat reception/dissipation members 10. This allows the heat emitted from the heat sources 100 to be distributed, as appropriate, to the surface of the plurality of heat reception/dissipation members 10, thus enabling efficient release of heat into the air.

That is, since heat can be efficiently dissipated, it is possible to ensure a sufficient amount of heat dissipation while the heat dissipation structure 1 is configured as a compact one.

Furthermore, in this embodiment, it is possible to release heat into the air, while the heat is being positively kept away from the heat sources 100, in both the planar direction of the heat reception/dissipation members 10 and the direction of arrangement of the heat reception/dissipation members 10, the directions intersecting each other (to be substantially orthogonal to each other). It is also possible to prevent such a case where heat builds up in the vicinity of the heat sources 100 so as to reduce the heat dissipation efficiency. Furthermore, as a result, since a blower fan can be eliminated, the heat dissipation structure 1 can be further made compact. Note that in order to facilitate heat transfer by heat radiation, for example, the surface of the expanded graphite layers 12 may be coated or impregnated with a material having a high heat emissivity or absorptivity, such as a heat radiation paint. That is, the expanded graphite layers 12 may also have a film containing a material having a high heat emissivity or absorptivity on the surfaces.

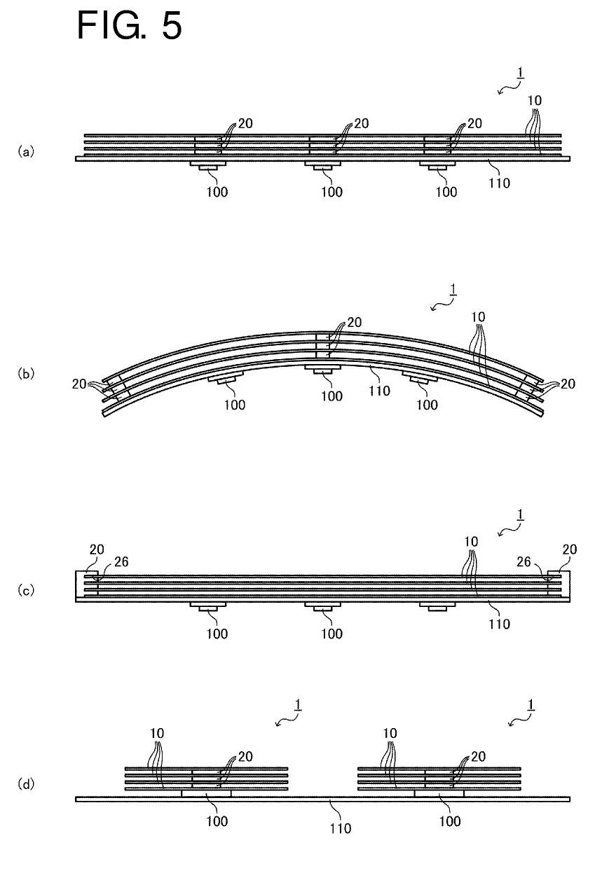

A description will next be given of another form of the heat dissipation structure 1. FIGS. 5(a) to 5(d), FIGS. 6(a) to 6(e), and FIGS. 7(a) and 7(b) are schematic views each illustrating, as an example, another form of the heat dissipation structure 1.

FIG. 5(a) is a schematic front view illustrating an example of a case where the connection members 20 are positioned corresponding to the heat sources 100, i.e., the positions of the heat sources 100 and the connection members 20 substantially match with each other in a plan view. As described above, the connection members 20 are disposed at the positions corresponding to the heat sources 100, thereby enabling heat from the heat sources 100 to be more positively distributed to each of the heat reception/dissipation members 10. For example, depending on the state of heat generation and the arrangement state of the heat sources 100 or the structure of a device in which the heat dissipation structure 1 is provided, such an arrangement enables more efficient heat dissipation.

Note that the connection members 20 may be disposed only at the positions corresponding to the heat sources 100, and as a matter of course, may also be disposed at other positions in addition to the positions corresponding to the heat sources 100.

FIG. 5(b) is a schematic front view illustrating an example of a case where the heat reception/dissipation members 10 are curved. The heat reception/dissipation members 10 may also be curved or bent depending on the substrate 110 on which the heat sources 100 are disposed or the shape of the housing of a device in which the heat dissipation structure 1 is provided. Note that FIG. 5(b) illustrates an example of the heat reception/dissipation members 10 that are curved in a substantially arcuate shape. However, for example, the heat reception/dissipation members 10 may also be curved or bent in the shape of letter C, L, or S, or another shape.

Furthermore, the heat reception/dissipation members 10 may also be configured in a cylindrical shape.

FIG. 5(c) is a schematic front view illustrating an example of a case where a plurality of heat reception/dissipation members 10 are fixed to one connection member 20. In the example shown in FIG. 5(c), parts of the heat reception/dissipation members 10 are inserted into grooves 26 formed in the connection member 20, so as to fix the heat reception/dissipation members 10. However, other known fixing methods may also be employed. Depending on the state of the heat sources 100, the connection member 20 is configured to be disposed across the plurality of heat reception/dissipation members 10 (the expanded graphite layers 12), thereby facilitating assembly of the heat dissipation structure 1 or efficiently distributing heat to the plurality of heat reception/dissipation members 10. Note that in this case, for example, the connection member 20 may also be integrated with another member such as the substrate 110.

FIG. 5(d) is a schematic front view illustrating an example of a case where the heat dissipation structure 1 is mounted not via the substrate 110 but directly on the heat sources 100. When the heat sources 100 are an electronic component, for example, a CPU, directly mounting the heat dissipation structure 1 to a heat source leads to efficient heat dissipation. Note that in this case, the heat reception/dissipation members 10 may also be bonded under pressure to the heat sources 100, or a heat dissipating grease may also be interposed therebetween. Furthermore, the heat dissipation structure 1 may also be mounted to the heat sources 100 via another member other than the substrate 110. Furthermore, as shown in FIG. 5(d), the heat dissipation structure 1 may be provided for each of the heat sources 100, or may also be provided across a plurality of heat sources 100.

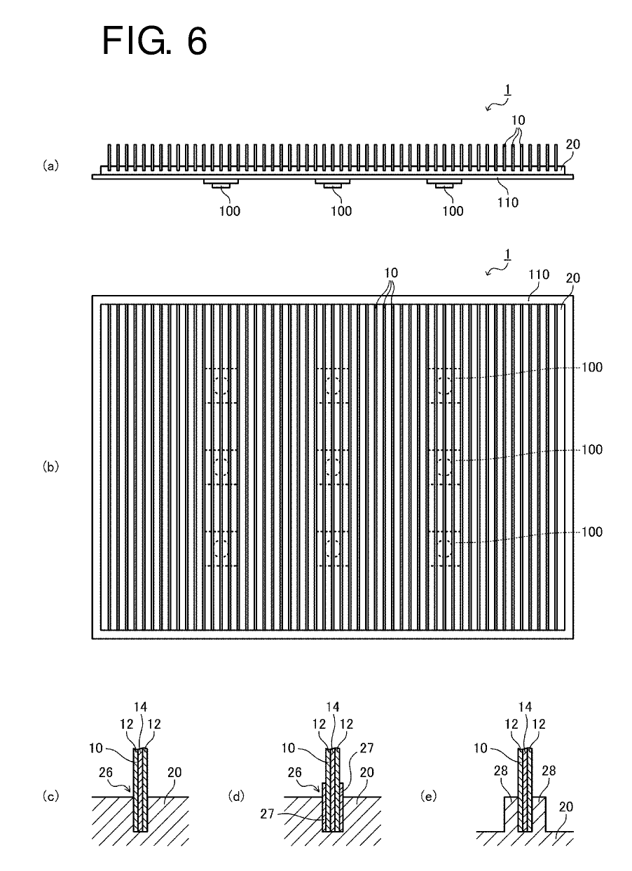

FIG. 6(a) is a schematic front view illustrating an example of a case where a plurality of heat reception/dissipation members 10 are fixed to one connection member 20, and the connection member 20 is disposed between the heat reception/dissipation members 10 and the heat sources 100. FIG. 6(b) is a schematic plan view illustrating the same example. In the example illustrated in FIGS. 6(a) and 6(b), the connection members 20 configured in a substantially flat shape are mounted on the substrate 110, and a plurality of heat reception/dissipation members 10 are provided to protrude on the surface of the connection member 20 opposite to the substrate 110. In this case, heat emitted from the heat sources 100 is transferred via the substrate 110 and the connection member 20 to the heat reception/dissipation members 10. Furthermore, the connection member 20 is disposed across the plurality of heat reception/dissipation members 10 (the expanded graphite layers 12).

Even with the heat dissipation structure 1 being configured in this manner, it is possible to release heat into the air, while the heat is being positively kept away from the heat sources 100, in both the planar direction of the heat reception/dissipation members 10 and the direction of arrangement of the heat reception/dissipation members 10. It is thus possible to efficiently dissipate heat though the heat dissipation structure 1 has a shape similar to that of a conventional heat dissipation structure. Furthermore, the expanded graphite layer 12 enables the heat dissipation structure 1 to be reduced in weight as compared with a conventional one.

FIGS. 6(c) to 6(e) are schematic cross-sectional views illustrating example methods for fixing the heat reception/dissipation members 10 to the connection member 20. For example, as shown in FIGS. 6(c) and 6(d), the heat reception/dissipation member 10 can be fixed by inserting part thereof into the groove 26 formed in the connection member 20. Furthermore, as shown in FIG. 6(e), the heat reception/dissipation member 10 can be fixed by inserting part thereof in between two projections 28 provided in the connection member 20.

At this time, the heat reception/dissipation member 10 may also be press fit into the groove 26 or in between the projections 28, or for example, an appropriate adhesive or heat dissipating grease may also be used to fill in a gap. Furthermore, as shown in FIG. 6(d), an appropriate fixing sheet 27 may be inserted in between the heat reception/dissipation member 10 and the groove 26 (or the projection 28), thereby filling in the gap between the heat reception/dissipation member 10 and the groove 26 (or the projection 28). It is thus possible to fix the heat reception/dissipation member 10 with stability by appropriately filling in the gap between the heat reception/dissipation member 10 and the groove 26 or the projection 28 as well as to prevent inhibition of heat transfer from the connection member 20 to the heat reception/dissipation member 10.

Note that in the examples illustrated in FIGS. 6(a) to 6(e), the connection member 20 may be configured from one member, or alternatively, may also be configured by combining a plurality of members. Furthermore, the connection member 20 may be configured integrally with the substrate 110, or may also be used as the substrate 110. That is, for example, the substrate 110 on which the heat sources 100 are disposed may be provided with the grooves 26 or the projections 28, thereby allowing the heat reception/dissipation members 10 to be directly fixed to the substrate 110.

Furthermore, the material of the connection member 20 for this case is not limited to a particular one, and for example, it is possible to use a material having a high thermal conductivity, such as aluminum and copper. Similarly, as for the material of the fixing sheet 27, for example, it is possible to use a material having a high thermal conductivity, such as aluminum and copper. Furthermore, in this case, as a matter of course, the attitude and the direction of arrangement of the heat reception/dissipation members 10 are not limited to particular ones. Furthermore, the methods for fixing the heat reception/dissipation members 10 are not limited to those examples illustrated in FIGS. 6(c) to 6(e), but it is possible to employ various types of known techniques.

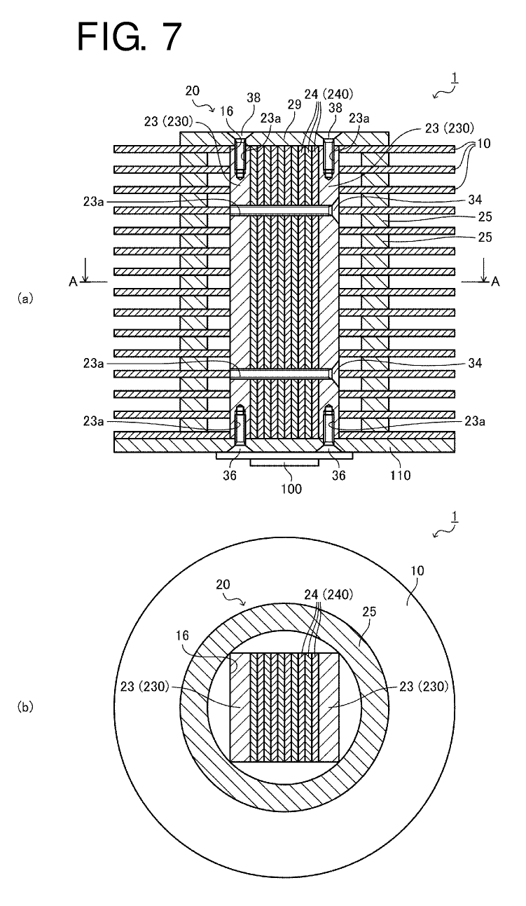

FIG. 7(a) is a schematic cross-sectional view illustrating an example of a case where the connection member 20 is provided with a plurality of expanded graphite layers 24, and the connection member 20 is inserted into through holes 16 formed in the plurality of heat reception/dissipation members 10. FIG. 7(b) is a cross-sectional view taken along line A-A in FIG. 7(a). In the examples illustrated in FIGS. 7(a) and 7(b), the connection member 20 is configured as a substantially quadrangular prism-shaped member by depositing a plurality of substantially rectangular plate-shaped expanded black smoke sheets 240 in between two substantially rectangular plate-shaped metal plates 230 and then tightening the two metal plates 230 together with flat screws 34.

That is, the connection member 20 of this example is configured to have a plurality of expanded graphite layers 24 in between the two metal layers 23. Like the examples shown in FIG. 2(b) and FIG. 3(d), the expanded graphite layers 24 provide an excellent thermal conductivity in the axial direction (in the vertical direction in FIG. 7(a)).

The heat dissipation structure 1 of this example is provided with the heat source 100 at the center of the substrate 110 configured in a substantially disc shape. Furthermore, the plurality of heat reception/dissipation members 10 are configured in a substantially disc shape like the substrate 110 and provided with the substantially rectangular through hole 16 at the center. Then, the connection member 20 is fixed with the flat screws 36 to the position corresponding to the heat source 100 on the surface opposite to the heat source 100, and the plurality of heat reception/dissipation members 10 are arranged in the axial direction of the connection member 20 with the connection member 20 inserted into the through hole 16. Thus, the connection member 20 (the expanded graphite layers 24) is disposed across the plurality of heat reception/dissipation members 10 (the expanded graphite layers 12) and substantially orthogonal to each of the heat reception/dissipation members 10 (each of the expanded graphite layers 12).

A substantially ring-shaped spacer 25 is disposed in between each of the heat reception/dissipation members 10. A substantially disc-shaped hord member 29 is fixed with flat screws 38 on the end surface of the connection member 20 opposite to the substrate 110. That is, in this example, the heat reception/dissipation members 10 and the spacers 25 are sandwiched between the hord member 29 and the substrate 110. This allows each of the heat reception/dissipation members 10 to be fixed to the substrate 110 and the connection member 20 with the members 10 being spaced from each other at appropriate intervals.

The heat dissipation structure 1 configured in this manner can prevent the plurality of expanded graphite layers 24 provided in the connection member 20 from being partitioned by the heat reception/dissipation members 10. It is thus possible to facilitate the transfer of heat within the connection member 20. This enables the heat from the heat source 100 to be immediately kept away from the heat source 100 along the connection member 20 (i.e., to be transferred in the direction of arrangement of the heat reception/dissipation members 10) and to be distributed to the heat reception/dissipation members 10 located farther away from the heat source 100. That is, in this example, since heat can be distributed to more heat reception/dissipation members 10, it is possible to efficiently dissipate heat even when the size (the size in the planar direction) of the heat reception/dissipation members 10 is restricted.

Furthermore, in this example, the plurality of expanded black smoke sheets 240 are sandwiched between the two metal plates 230 to thereby configure the connection member 20 having the plurality of expanded graphite layers 24 relatively in a simplified manner as well as to protect the expanded graphite layers 24 made of a brittle material. Furthermore, the metal layer 23 is configured from a relatively thick metal plate 230 to thereby ensure the strength and rigidity of the connection member 20 and support the plurality of heat reception/dissipation members 10 with reliability. Furthermore, screw holes 23a into which the respective flat screws 34, 36, and 38 are screwed are formed in the metal layer 23 to thereby facilitate assembly of the connection member 20 as well as to facilitate attachment of the heat reception/dissipation members 10 and the connection member 20 to the substrate 110.

Note that the gap between the through hole 16 of the heat reception/dissipation members 10 and the connection member 20 may also be filled with a heat dissipating grease or the like, and as well, a space between the spacers 25 and the connection member 20 may also be filled with a heat dissipating grease or the like. This enables transfer of heat between the connection member 20 and the heat reception/dissipation members 10.

Furthermore, the arrangement configuration of the metal layers 23 and the expanded graphite layers 24 is not limited to a particular one. For example, a plurality of expanded graphite layers 24 may also be provided on both sides of one metal layer 23, and the metal layer 23 and the expanded graphite layer 24 may also be alternately provided. Furthermore, like the examples shown in FIG. 2(b) and FIG. 3(d), the expanded graphite layer 24 may also be formed in a spiral shape. Furthermore, the material of the metal layer 23 is not limited to a particular one so long as the material has a high thermal conductivity like aluminum or copper, and the expanded graphite layer 24 may also contain various types of binders or metals other than the expanded graphite.

Furthermore, the thickness of the metal layer 23 may be appropriately determined depending on, for example, the strength required for the connection member 20. For example, depending on the required strength, the metal layer 23 may also be eliminated. Alternatively, in conjunction with the metal layer 23 or in place of the metal layer 23, a layer of resin or ceramics may also be provided. Furthermore, the material of the spacer 25 and the Nord member 29 is not limited to particular ones. However, the materials preferably have a high thermal conductivity like aluminum or copper. Furthermore, like the connection member 20, the spacer 25 and the hord member 29 may also have the expanded graphite layer 24.

Furthermore, the shapes of the connection member 20, the spacer 25, and the hord member 29 are not limited to particular ones. It is possible to employ various types of shapes. Furthermore, the connection member 20 may be fixed to the substrate 110 and the hord member 29 may be fixed to the connection member 20 according to other known techniques. Furthermore, the connection member 20 may also be configured, for example, by pressing the metal plates 230 and the expanded graphite sheets 240 together under pressure or by coupling the same together with an appropriate adhesive. Furthermore, if an appropriate adhesive or a mating structure can maintain the intervals between the heat reception/dissipation members 10, then the spacer 25 and the hord member 29 may also be eliminated.

Furthermore, for example, the groove 26 and the like may also be provided on the metal layer 23 to thereby apply the structure of the connection member 20 according to this example to the heat dissipation structure 1 illustrated in FIG. 5(c) or FIGS. 6(a) and 6(b). Furthermore, the structure of the connection member 20 according to this example may also be applied to the connection member 20 disposed between the heat reception/dissipation members 10. Furthermore, a connection member 20 made of an appropriate material having a high thermal conductivity and having no expanded graphite layer 24 may also be inserted into the through holes 16 of the heat reception/dissipation members 10. That is, for example, the bolt 30 shown in FIG. 2(a) may also be employed as the connection member 20.

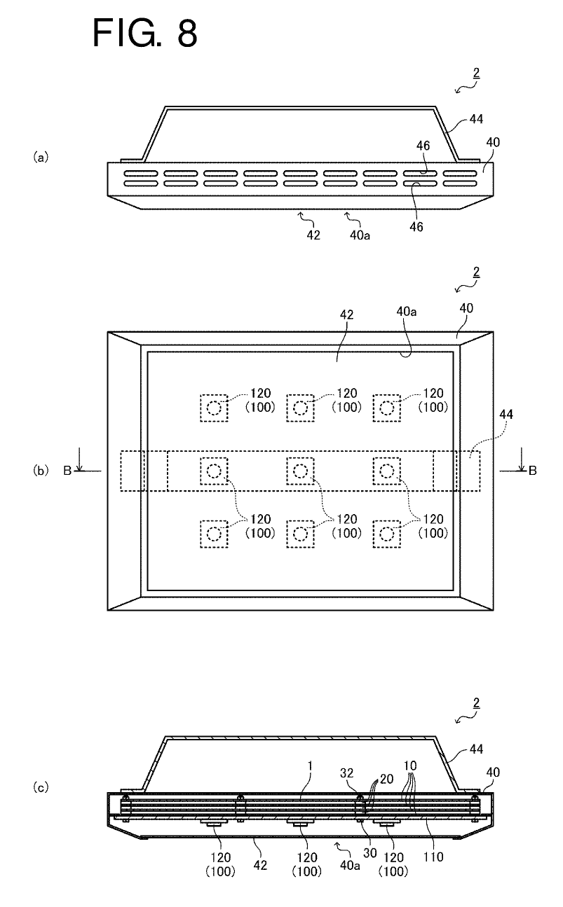

A description will next be given of an illumination device 2 according to this embodiment. FIG. 8(a) is a schematic front view illustrating the illumination device 2 according to this embodiment; FIG. 8(b) is a schematic bottom view illustrating the illumination device 2; and FIG. 8(c) is a cross-sectional view taken along line B-B in FIG. 8(b). As illustrated in these figures, the illumination device 2 is provided with nine LED modules 120 as light sources and also with the heat dissipation structure 1 for dissipating heat emitted from the LED modules 120.

The illumination device 2 is provided with a substantially box-shaped housing 40 with a large opening on one end (the lower portion in FIGS. 8(a) and (b)), and the opening 40a of the housing 40 is provided with a translucent diffusion plate 42 for diffusing and transmitting the light emitted from the LED modules 120. Furthermore, on the side of the housing 40 opposite to the opening 40a (the upper portion in FIGS. 8(a) and 8(b)) is provided a bracket 44 for fixing the illumination device 2.

The substrate 110 on which the LED modules 120 are disposed is fixed inside the housing 40, and the heat dissipation structure 1 is mounted on the substrate 110 while being accommodated inside the housing 40. The housing 40 is provided with a plurality of heat dissipating holes 46 arranged as appropriate, so that the air heated by the heat dissipation structure 1 is released out of the housing 40 through the heat dissipating holes 46, and the cool air outside the housing 40 is introduced into the housing 40 through the heat dissipating holes 46.

The heat dissipation structure 1 as described above is capable of efficiently dissipating heat in a compact configuration reduced in weight without requiring a blower fan or the like. It is thus possible to make the illumination device 2 more compact and reduced in weight than before while the illumination device 2 emits the same amount of light. Furthermore, the heat dissipation structure 1 can be accommodated inside the housing 40, thereby providing an enhanced freedom of design for the illumination device 2.

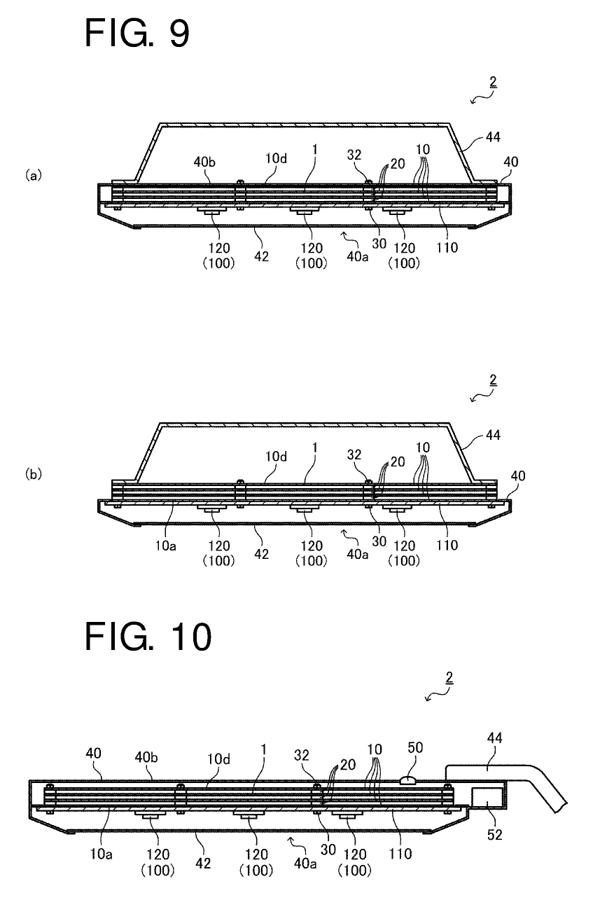

A description will next be given of another form of the illumination device 2. FIGS. 9(a) and 9(b) are schematic cross-sectional views illustrating, as an example, the illumination device 2 in another form.

FIG. 9(a) illustrates an example of a case where the heat reception/dissipation member 10d of the heat dissipation structure 1 that is the farthest from the LED modules 120 (the heat sources 100) is in close contact with the housing 40. In this example, the heat reception/dissipation member 10d is in intimate contact with an upper surface portion 40b of the housing 40 opposite to the opening 40a. Note that the intimate contact between the upper surface portion 40b and the heat reception/dissipation member 10d may be achieved by bonding together under pressure, for example, by press, or may also be achieved by tightening with the bolt 30 and the nut 32. The heat reception/dissipation member 10d having been brought into close contact with the housing 40 as described above enables the heat from the LED modules 120 to be transferred to the housing 40 as well. It is thus possible to dissipate heat with improved efficiency depending on, for example, the arrangement configuration of the LED modules 120 or the shape of the housing.

Note that part of the housing 40 may also be used as the heat reception/dissipation member 10d. In this case, for example, an expanded graphite sheet may be bonded under pressure to the inner and outer surfaces of part of the housing 40 to be thereby used also as the heat reception/dissipation member 10d. Furthermore, in this case, the expanded graphite sheet may also be bonded under pressure only to the inner surface of part of the housing 40. That is, from the viewpoint of damage to the expanded graphite layer 12 or the design of the illumination device 2, if the expanded graphite layer 12 is preferably not exposed to outside, the heat reception/dissipation member 10d may also be configured to have the expanded graphite layer 12 only as the outermost layer close to the adjacent heat reception/dissipation member 10c.

FIG. 9(b) illustrates an example of a case where the heat dissipation structure 1 is disposed outside the housing 40. For example, depending on the arrangement configuration of the LED modules 120 or the shape of the housing, the heat dissipation structure 1 may be exposed outside in this manner, thereby enabling heat to be dissipated more efficiently. Note that in this case, the heat dissipation structure 1 may also be configured to receive heat from the LED modules 120 via part of the housing 40, or part of the housing 40 may also be used as the heat reception/dissipation member 10a closest to the LED modules 120.

Furthermore, if the expanded graphite layer 12 may be preferably not exposed to outside, the heat reception/dissipation member 10d farthest from the LED modules 120 may also be configured to have the expanded graphite layer 12 only as the outermost layer close to the adjacent heat reception/dissipation member 10c. Furthermore, the heat dissipation structure 1 may also be partially exposed to outside the housing 40, in the case of which part of the housing 40 may be used also as any one of the plurality of heat reception/dissipation members 10.

FIG. 10 is a schematic cross-sectional view illustrating an example of a case where the illumination device 2 is configured as a street light. In this case, the housing 40 is configured to be waterproof, as appropriate, and the bracket 44 is configured to be capable of being mounted to a utility pole or an illumination pole. Furthermore, the illumination device 2 of this example is provided with an illuminance sensor (optical sensor) 50 having a known structure and a control device 52 having a known structure, and configured such that the control device 52 controls the turning off and on of the LED modules 120 depending on the quantity of light (brightness) detected by the illuminance sensor 50. That is, the illumination device 2 of this example is configured to be automatically turned on when it has got dark after sunset and automatically turned off when it has got light at sunrise.

According to the heat dissipation structure 1, while being diffused in the planar direction of the heat reception/dissipation members 10, the heat emitted from the LED modules 120 as described above is to be transferred from the heat reception/dissipation member 10a closest to the LED modules 120 to the heat reception/dissipation member 10d farthest from the LED modules 120. Thus, the upper surface portion 40b of the housing 40 is to be heated substantially uniformly by the heat dissipation structure 1.

The illumination device 2 of this example effectively employs the effects of the heat dissipation structure 1 described above so as to provide the upper surface portion 40b of the housing 40 with a function of melting snow. That is, although snow will be accumulated on the upper surface portion 40b of the housing 40 at snowfall, the upper surface portion 40b can be heated moderately by the heat emitted from the LED modules 120, thereby melting the snow accumulated on the illumination device 2 without providing an additional heater or the like. In particular, according to the heat dissipation structure 1, the heat emitted from the LED modules 120 can be efficiently diffused and then transferred to the upper surface portion 40b, thus allowing snow to be efficiently melted while resisting uneven melting of snow.

Furthermore, in this example, the illuminance sensor 50 is disposed on the upper surface portion 40b of the housing 40, thereby allowing the LED modules 120 to be turned on even when accumulated snow blocks light. Thus, when snow is accumulated on the illumination device 2, the illumination device 2 of this example causes the LED modules 120 to be automatically turned on even when the surroundings are bright, allowing the heat generated thereby to melt the accumulated snow. Furthermore, since the LED modules 120 will be automatically turned off when the surroundings are bright after snow has been melted, unnecessary power will not be consumed.

As described above, the illumination device 2 of this embodiment is provided with the heat dissipation structure 1, thereby enabling snow to be efficiently melted using the heat emitted from the LED modules 120. Furthermore, as a result, effective use of the automatic on/off function enables automatic melting of snow, thereby providing preferred use of a street light especially in a region where there is a plenty of snowfall.

Note that even in this case, as a matter of course, the heat reception/dissipation member 10d farthest from the LED modules 120 may be brought into intimate contact with the upper surface portion 40b of the housing 40, or the upper surface portion 40b of the housing 40 may be used also as the heat reception/dissipation member 10d. Furthermore, the position at which the illuminance sensor 50 is disposed is not limited to a particular one, but may be disposed at an appropriate position.

As described above, the heat dissipation structure 1 according to this embodiment is configured to release heat from the heat sources 100, the heat dissipation structure 1 being provided with: a plurality of heat reception/dissipation members 10 which have the expanded graphite layers 12 containing expanded graphite and which are spaced apart from each other; and a connection member 20 configured to connect together the heat reception/dissipation members 10. The heat reception/dissipation members 10 each have the expanded graphite layers 12 as an outermost layer and are disposed such that the expanded graphite layers 12 face each other.

Such a configuration enables heat to be transferred to a plurality of heat reception/dissipation members 10 by heat transfer via the connection member 20 and by heat radiation between the mutually opposed expanded graphite layers 12 while allowing heat to be diffused along the expanded graphite layers 12. It is thus possible to dissipate heat in a simplified and efficient manner.

Furthermore, the heat reception/dissipation members 10 are arranged in a direction in which a distance from the heat sources 100 increases. This enables heat to be dissipated by heat transfer and heat radiation via the connection member 20 while the heat is positively being kept away from the heat sources, thereby preventing the heat from being built up in the vicinity of the heat sources 100 and efficiently dissipating the heat. Furthermore, by eliminating a blower fan, it is possible to form the heat dissipation structure 1 in a compact configuration reduced in weight.

Furthermore, the heat reception/dissipation members 10 are configured such that the expanded graphite layers 12 are disposed so that the expanded graphite layers 12 intersect a direction in which the heat reception/dissipation members 10 are arranged. This enables heat to be kept away from the heat sources 100 in a plurality of directions, thereby dissipating heat more efficiently and allowing the heat dissipation structure 1 to have a more compact configuration reduced in weight.

Furthermore, the heat reception/dissipation member 10 has the metal layer 14 made of a metal, and the expanded graphite layer 12 is provided on both sides of the metal layer 14. This enables the heat reception/dissipation member 10 to have an appropriate strength and rigidity, thereby enhancing the durability and versatility of the heat dissipation structure 1.

Furthermore, the connection member 20 has a connection expanded graphite layer containing expanded graphite (the expanded graphite layer 24), and the connection expanded graphite layer is provided so as to intersect the expanded graphite layer 12. This enables heat transfer to be facilitated in the connection member 20, thereby dissipating heat more efficiently.

Furthermore, the connection member 20 has the connection expanded graphite layer in a spiral shape (the expanded graphite layer 24). Furthermore, the connection member 20 may also have a plurality of connection expanded graphite layers (the expanded graphite layers 24). This makes it possible to readily configure the connection member 20 having a high thermal conductivity in the axial direction.

Furthermore, the connection member 20 has a connection metal layer (the metal layer 23) made of a metal, and the connection metal layer may be provided substantially in parallel to the connection expanded graphite layer (the expanded graphite layer 24). This ensures the strength and rigidity of the connection member 20, while enhancing the thermal conductivity in the axial direction, and allows for supporting the heat reception/dissipation members 10 with reliability. Furthermore, the connection member 20 can be readily attached to the substrate 110 and the heat sources 100.

Furthermore, the connection member 20 may also be disposed across the plurality of heat reception/dissipation members 10. Furthermore, the connection member 20 may also be inserted into a through hole formed in the heat reception/dissipation members 10. This enables the heat dissipation structure 1 to be assembled readily and heat to be distributed efficiently to the plurality of heat reception/dissipation members 10.

Furthermore, the connection member 20 may also be disposed between the heat source 100 and the heat reception/dissipation member 10. This makes it possible to dissipate heat efficiently even in a shape similar to that of the conventional heat dissipation structure.

Furthermore, the illumination device 2 according to this embodiment is provided with the heat dissipation structure 1 and the light sources configured to emit light (the LED modules 120). This makes it possible to dissipate heat emitted from the light sources in a simplified and efficient manner. Furthermore, as a result, it is possible to form the illumination device 2 in a compact configuration reduced in weight and provide an enhanced freedom of design to the illumination device 2.

Furthermore, the illumination device 2 is provided with the illuminance sensor 50 configured to detect ambient brightness, and the control device 52 configured to control turning on and turning off of the light sources (the LED modules 120) on the basis of a detection result provided by the illuminance sensor 50. This enables not only the light sources to be automatically turned on and turned off depending on ambient brightness but also the dissipated heat to be used to automatically melt snow.

As described above, although the embodiments of the present invention have been described, the heat dissipation structure and the illumination device of the present invention are not limited to the aforementioned embodiments, and as a matter of course, may be subjected to various modifications without departing from the spirit and scope of the present invention. For example, the shape of each part and the arrangement configuration of the heat dissipation structure 1 and the illumination device 2 are not limited to those illustrated in the aforementioned embodiments, and it is possible to employ any other shape and arrangement configuration.

Furthermore, the heat source 100 is not limited to electronic components such as LEDs or CPUs but may also be anything so long as it emits heat. Furthermore, as a matter of course, the shape and the arrangement configuration of the heat sources 100 are not limited to those illustrated in the aforementioned embodiments. Furthermore, as a matter of course, the light sources provided in the illumination device 2 may also be those other than LEDs.

Furthermore, the heat reception/dissipation members 10 may be disposed at constant intervals, or may also be disposed at different intervals depending on the position. Furthermore, the heat reception/dissipation member 10 may have a layer other than the expanded graphite layer 12 and the metal layer 14, or may also have only the expanded graphite layer 12. Furthermore, the expanded graphite layer 12 may also include a reinforcement mesh that is made of an appropriate material, such as a metal or a resin. Furthermore, the expanded graphite layer 12 may have an appropriate protective film made of a resin or the like on the surface, in the case of which the protective film is of a material that preferably does not inhibit the radiation and absorption of heat, for example, by transmitting electromagnetic waves, and more preferably facilitates the radiation and absorption of heat.

Furthermore, the connection member 20 may also include a reinforcement mesh made of an appropriate material in the expanded graphite layer 24. Furthermore, the connection member 20 may also be configured by combining multiple types of materials, for example, by winding an expanded graphite sheet around a core member made of a metal.

Furthermore, the operations and effects illustrated in the aforementioned embodiments are merely the most preferred ones that result from the present invention, and the operations and effects by the present invention are not limited thereto.

The heat dissipation structure according to the present invention is applicable to the field of dissipation of heat from various types of heat sources or high-temperature portions other than electronic components generating a large amount of heat, such as LEDs or CPUs. On the other hand, the illumination device according to the present invention is also applicable to the field of various types of illumination devices other than illumination devices that employ LEDs.

### REFERENCE SIGNS LIST

1 heat dissipation structure
2 illumination device
10 heat reception/dissipation member
12 expanded graphite layer
14 metal layer
20 connection member
23 metal layer
24 expanded graphite layer
50 illuminance sensor
52 control device
100 heat source
120 LED module
200 expanded graphite tape

1. A heat dissipation structure configured to release heat from a heat source, comprising:
a plurality of heat reception/dissipation members having an expanded graphite layer containing expanded graphite, the heat reception/dissipation members being spaced apart from each other; and
a connection member configured to connect together the heat reception/dissipation members, wherein the heat reception/dissipation members each have the expanded graphite layer as an outermost layer and are disposed such that the expanded graphite layers face each other.

2. The heat dissipation structure according to claim 1, wherein the heat reception/dissipation members are arranged in a direction in which a distance from the heat source increases.

3. The heat dissipation structure of claim 1, wherein the heat reception/dissipation members are disposed so that the expanded graphite layers intersect a direction in which the heat reception/dissipation members are arranged.

4. The heat dissipation structure of claim 1, wherein:
the heat reception/dissipation member has a metal layer made of a metal; and
the expanded graphite layer is provided on both sides of the metal layer.

5. The heat dissipation structure of claim 1, wherein:
the connection member has a connection expanded graphite layer containing expanded graphite; and
the connection expanded graphite layer is provided so as to intersect the expanded graphite layers.

6. The heat dissipation structure according to claim 5, wherein the connection member has the connection expanded graphite layer formed in a spiral shape.

7. The heat dissipation structure of claim 5, wherein the connection member has a plurality of the connection expanded graphite layers.

8. The heat dissipation structure of claim 5, wherein:
the connection member has a connection metal layer made of a metal; and
the connection metal layer is provided substantially in parallel to the connection expanded graphite layer.

9. The heat dissipation structure of claim 1, wherein the connection member is disposed across the plurality of heat reception/dissipation members.

10. The heat dissipation structure according to claim 9, wherein the connection member is inserted into a through hole formed in the heat reception/dissipation members.

11. The heat dissipation structure according to claim 9, wherein the connection member is disposed between the heat source and the heat reception/dissipation member.

12. An illumination device comprising:
the heat dissipation structure of claim 1; and
a light source configured to emit light.

13. The illumination device according to claim 12, comprising:
an illuminance sensor configured to detect ambient brightness; and
a control device configured to control turning on and turning off of the light source on a basis of a detection result provided by the illuminance sensor.
